(19) United States
(12) Patent Application Publication
(10) Pub. No.: US 2005/0172392 A1
(43) Pub. Date: Aug. 11, 2005

(54) Air bath

(76) Inventors: Peter W. Swart, Oostburg, WI (US); Mike Yoshiaki Daikubara, Fox Point, WI (US); Diana Wang, Sheboygan, WI (US)

Correspondence Address: QUARLES & BRADY LLP, 411 E. WISCONSIN AVENUE, SUITE 2040, MILWAUKEE, WI, 53202-4497, US

(21) Appl. No.: 10/774,123

(22) Filed: Feb. 6, 2004

(51) Int. Cl. A61H 33/06

(52) U.S. Cl. 4/541.5

(57) ABSTRACT

An air bath has air jets arranged in rows extending around the side walls of the water basin. The rows of air jets are spaced vertically so that they are at different heights within the basin and so that air jets in the higher row(s) realize less pressure from the water in the basin. Air is delivered to the air jets through a ring-like air manifold formed of a single channel or multiple channels, the latter allowing for air flow control to different zones of the tub.

### CROSS-REFERENCE TO RELATED APPLICATIONS

Not applicable.

### STATEMENT OF FEDERALLY SPONSORED RESEARCH OR DEVELOPMENT

Not applicable.

### BACKGROUND OF THE INVENTION

The present invention relates to tubs such as bathtubs in which air is bubbled into the water to create a hydrotherapy action.

Therapeutic water baths and pools are well-known. Spas or whirlpool tubs are common examples in which water streams from jets through the walls of the basin flow into the water beneath the surface, usually directed at large muscle areas of a person's body, for example shoulders, back and thighs. The force from the jets “massage” the bather directly as well as agitate the water to provide therapeutic effects for other parts of the body not directly in the path of the jets. U.S. Pat. No. 6,185,757 discloses one such bath with water jets.

Although water jets are common, some tubs use air streams to agitate the water. For example, U.S. Pat. No. 5,898,958 discloses one tub that introduces water or air streams into the water. A special control and valve arrangement controls the flow air to a sets of jets in the walls of the tub. Air is passed from an air pump through a manifold and several conduits to the jets. A three-way valve is controlled by the operator to pump air only to dedicated air jets, to only a set of water jets where the water is mixed with air, or to both the water and air jets.

The air pump has two speeds for different levels of agitation. The jets are arranged as arrays with multiple columns and rows at a specific locations in the walls of the tub. For example, the water jets are located at the lower lumbar region and the air jets are located at the bather's feet. Thus, while providing targeted massage, this tub maybe somewhat ineffective for full-body therapy. Moreover, the delivery system is very complex and requires several flexible conduits, one for each jet.

U.S. Pat. No. 6,317,903 uses air jets arranged in spaced apart fashion essentially in a single row extending around the walls of the tub. Air (or ozone) is delivered from a blower to the air jets by an air distribution duct secured to the outer surface of the side walls. Provisions for dividing the air flow to body specific zones are also discussed.

Air distribution in this system is less than optimal because the jets farthest from the blower can effectively become blocked by the pressure head of the water contained in the tub, particularly when the blower speed is decreased. Consequently, less than full body treatment may be occur.

Thus, a need exists for an improved system for infusing bath water with air.

### SUMMARY OF THE INVENTION

The invention provides an air bathtub. The basin has a bottom and side walls with a plurality of air jets arranged in spaced relation in a plurality of rows extending essentially around the entire perimeter of the side walls, with each row at a different height. An air manifold extends around the side walls of the basin in communication with the air jets.

In preferred forms, there are at least three rows of air jets in the lower half of the side walls. The rows of air jets are spaced apart vertically no less than ½ inch, and preferably ⅝ inch. The air jets themselves are less than ¼ inch in diameter, and preferably 3/32 inch to ⅛ inch in diameter. There are preferably 40 air jets in each row spaced apart about two inches. Also, the air jets of at least one of the rows is vertically staggered with respect to one or more of the other rows.

In other preferred forms, the air manifold is integral with an outer side of the side walls, being either a separate piece mechanically attached to the basin or being formed as a unitary part of the basin. The air manifold can be a single air channel having an interior in communication with all of the air jets. In this case, the entire bath is supplied with air when the system is on. Alternatively, the air manifold can have a plurality of air channels, preferably arranged in series to from a ring around the basin. In this case, each air channel is isolated from the others, either permanently or by a valve, and each air channel is in communication air jets in a particular zone of the basin, for example, head, foot, thoracic or lumbar zones. Each zone can then be supplied with air independently, alone or in combination with other zones, as desired by the bather.

A control interface allows the user to quickly and easily adjust the air to one or more zones by the press of a button. The control can also be used to control the speed of the air pump or blower to adjust the air flow rate through the manifold, and thus the amount of bubbles in the water.

Hence, the tubs of the present invention permit air to be supplied all the way around the tub using a low pressure pump or blower. Further, the tubs are resistant to a tendency for “dead spots” to arise in areas of the bath water where little or no air is flowing.

These and other advantages of the invention will be apparent from the detailed description and drawings.

### BRIEF DESCRIPTION OF THE DRAWINGS

FIG. 1 is a perspective view of an air bath having an air system according to the present invention, shown without the air delivery system;

FIG. 2 is a side elevational view thereof with a section of an air manifold shown cut-away;

FIG. 3 is a partial sectional view, taken along line 3-3 of FIG. 2, showing rows of air jets;

FIG. 4 is an enlarged partial section view thereof;

FIG. 5 is a planar view showing a hole pattern of the air jets;

FIG. 6 is a top plan view of the bathtub as shown in FIG. 1;

FIG. 7 is a bottom plan view thereof; and

FIG. 8 illustrates schematically the air delivery system in an alternate embodiment of the air bath in which there are multiple zones that can be independently controlled to provide focused air flow if full body treatment is not desired.

### DETAILED DESCRIPTION OF THE PREFERRED EMBODIMENTS

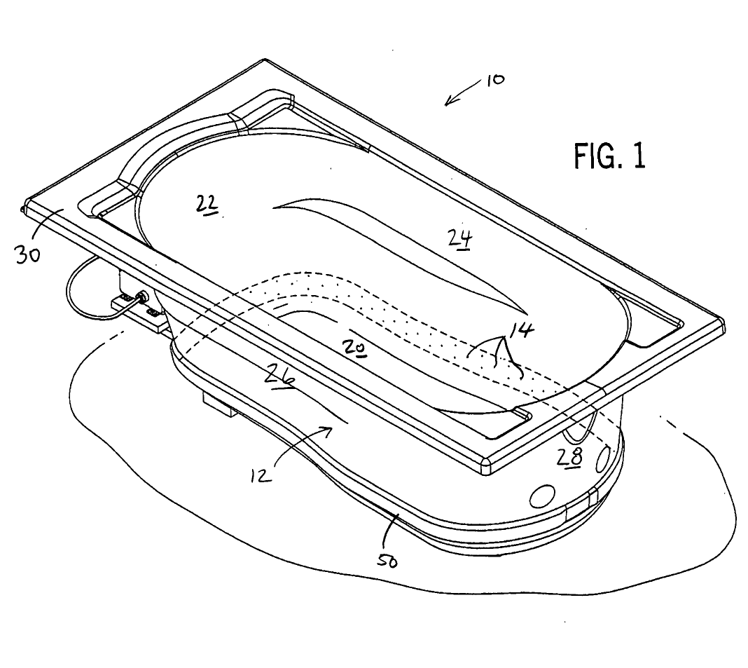

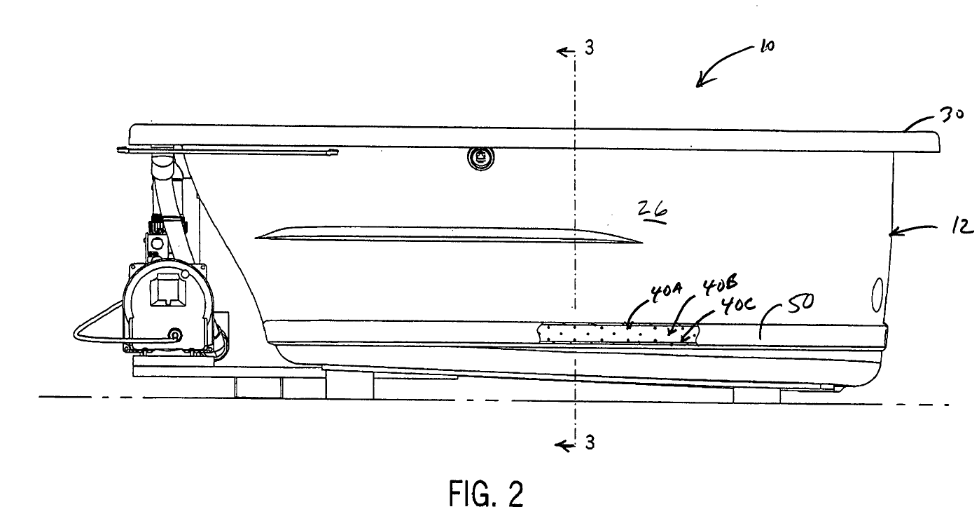

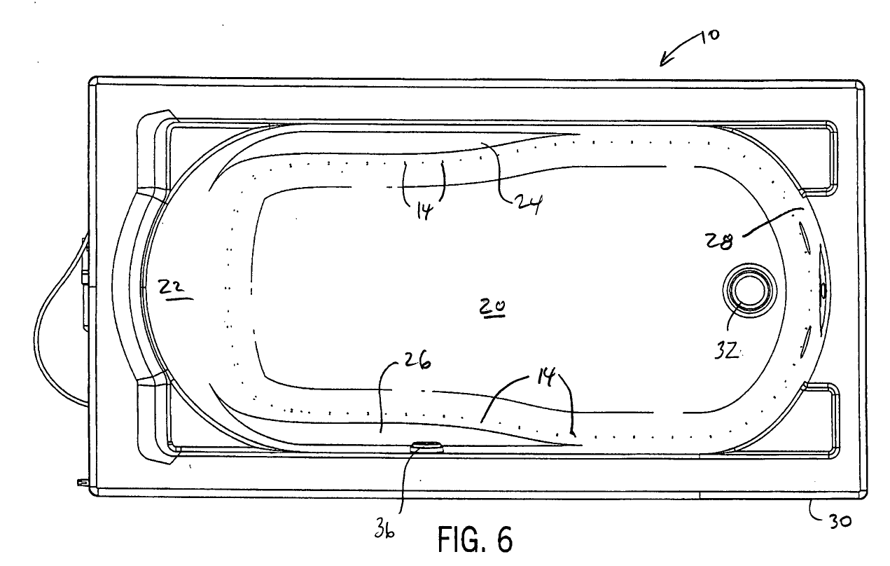

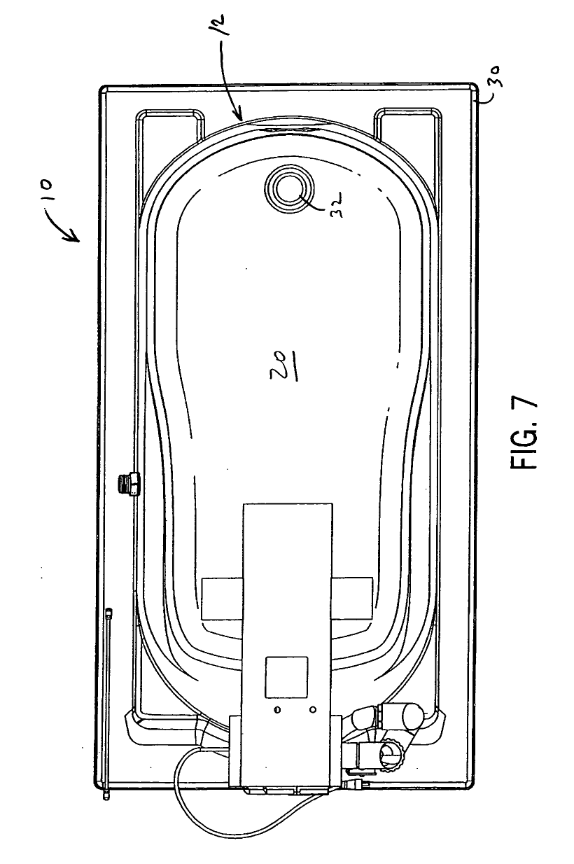

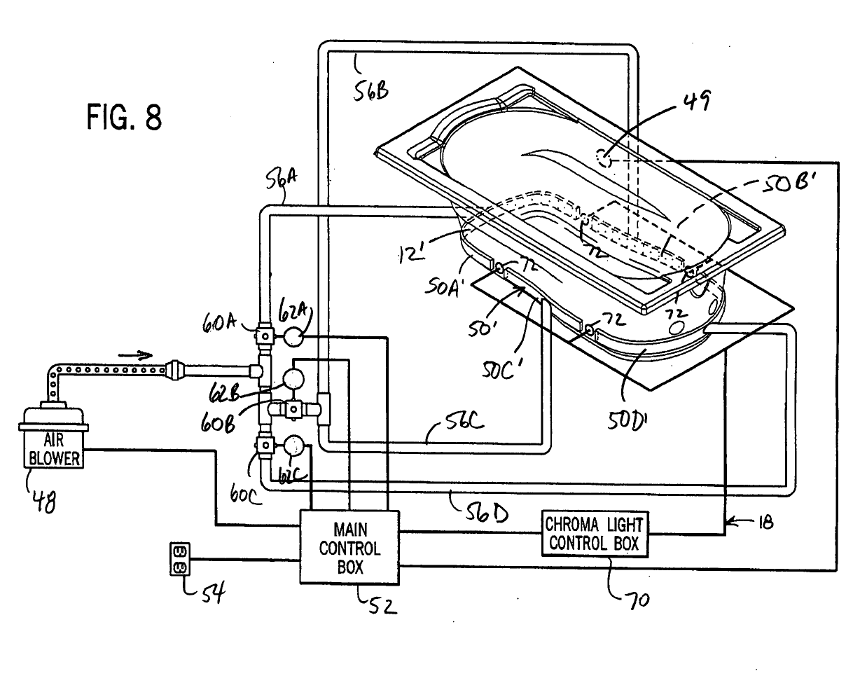

The present invention provides an air bath 10. FIGS. 1-7 illustrate the configuration of its basin 12 as well as the arrangement of air jets 14. FIG. 8 illustrates schematically the air delivery system that can be used with the basin of FIGS. 1-7 as well as the basin 12′ shown in FIG. 8. The difference between the two basins is that the basin 12′ is specially configured, as will be described, to provide selective control of air flow to prescribed zones, for example, head, lumbar, and foot zones. FIG. 8 also illustrates that the air bath can include a chromatherapy system 18 to illuminate the bath water various colors. A suitable chromatherapy system is disclosed in U.S. Pat. No. 6,360,380 and application Ser. No. 10/068,395, filed Feb. 6, 2002, both assigned to the assignee of the present invention and hereby incorporated by reference as though fully set forth herein. Also, in any case, the tub basin can be configured as a conventional bathtub, whirlpool, spa or swimming pool.

Referring to FIGS. 1, 2, 6 and 7, the basin 12 of the air bath 10 has a bottom 20 and contoured upright side walls defining a backrest 22, long side walls 24 and 26, and a foot end wall 28. A top ledge 30 extends around the top periphery of the side walls. The bottom 20 has a drain opening 32 with a drain stop controlled remotely by actuator 36 having an overflow feature. The side walls are formed with a plurality of openings near the bottom 20 (or at least somewhere in the lower half of the side walls) that define the air jets 14.

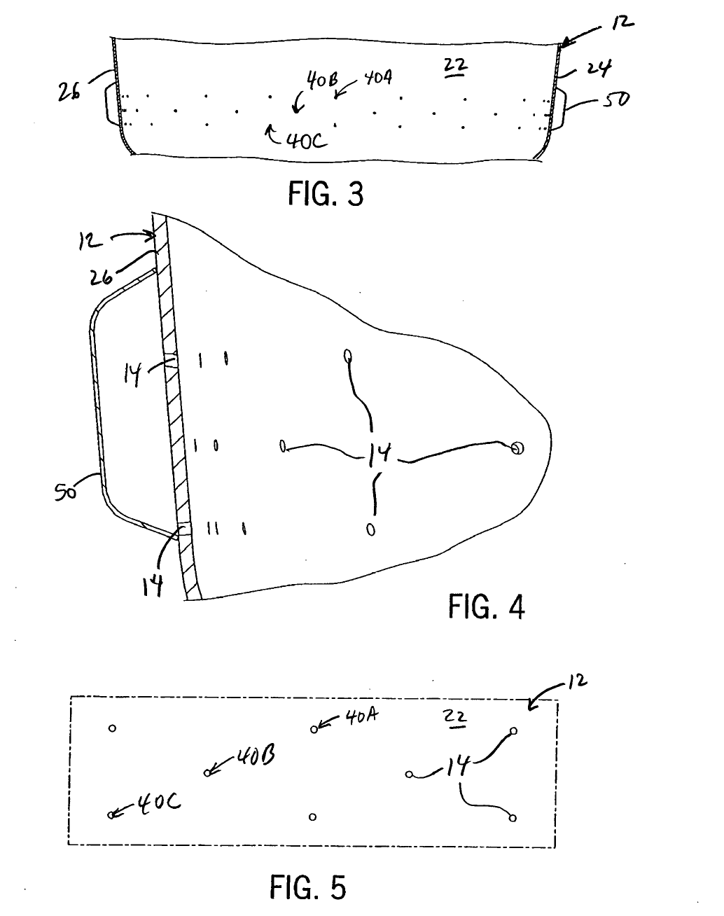

As shown in FIGS. 3-6, the air jets 14 are simple round holes extending though the thickness of the side walls. The air jets themselves are preferably circular and less than ¼ inch in diameter, more preferably about 3/32 inch to ⅛ inch in diameter. All of the air jets 14 can have an essentially uniform diameter or they can vary by row and/or distance from the air supply.

The openings are arranged in a special pattern designed specifically to provide improved air flow for full body air induced hydrotherapy. The air jets 14 are arranged in a plurality of lateral (or horizontal) rows. Three rows 40A, 40B and 40C are shown in the drawings. The air jets 14 of each row are spaced apart from each other, approximately two inches, and the air jets 14 of row 40B are staggered vertically so that they are offset from the vertical columns formed by the air jets 14 of rows 40A and 40C (see FIG. 5). In a conventionally sized bathtub, there are preferably about 40 air jets in each row, however, this can vary based on the size of the basin and the spacing between the air jets. Twenty to sixty or more air jets is thus be envisioned. In any case, it is important that the quantity and spacing of the air jets 14 be selected so that the air jets 14 essentially ring the entire perimeter of the side walls so that a full body treatment can be achieved.

All three of the rows 40-40C are near the bottom 20 and preferably do not extend into the upper half of the side walls. More preferably, each row is spaced apart vertically about ⅝ inch. Much less than about ½ inch vertical spacing has been determined to be too small to achieve the desired benefits discussed below. The upper range of the spacing is limited by other factors, such as the height of the side walls, the intended water depth in the basin, whether a single manifold will be used, and if so the ability to achieve sufficient force through the jets without too stringent of air flow requirements.

The vertical spacing of the rows 40A-40C provides an important aspect of the invention. The pressure head created by the water in the basin will be different for air jets at different depths, namely the pressure head being lesser for the higher air jets. Thus, as is possible in prior art systems, some of the air jets may become effectively blocked by the pressure head, particularly those air jets farthest from the air supply. Unlike prior art systems, however, should this happen in the system of the present invention, air can still flow from air jets in one or more of the higher rows because of the decreased pressure head. Moreover, because the rows of air jets in the present invention extend along the entire perimeter of the side walls, full body treatment can be achieved and maintained without unintended “dead spots” in the water where little or no air flow occurs because the air jets become effectively blocked. This benefit also allows the bather to select more or less agitation without creating dead spots. Dead spots are more likely to occur when the air flow is decreased since less force is generated by the air. So, in conventional systems having adjustable flow control, a bather desiring a more subtle treatment could slow the air flow, however for example, when the desired bubbling at the head was achieved, the water may not be agitated significantly (if at all) at the bather's feet. This problem is avoided by the air jet arrangement of the present invention because in areas where air jets may become blocked by pressure head (such as areas most remote from the air supply) air jets in one or more of the upper rows will still be able to emit air because of the lower pressure head.

With reference to FIGS. 1, 2-4 and 7, air is delivered from an air pump or blower (shown schematically as element 48 in FIG. 8) into an air manifold 50. In the embodiment shown in FIGS. 1-7, the air manifold 50 is a single channel which rings the entire (outer side) perimeter of the side walls such that its interior is in communication with the air jets in all three rows. The embodiment shown in FIG. 8 has an air manifold 50′ in which a series of discrete channels are in communication with groups of air jets corresponding to different treatment zones. It is important to note, however, that in either case the single channel or series of channels rings essentially the entire perimeter of the side walls sufficient to achieve full body treatment. Also, in either case, the air manifold can be a separate channel (or channels) mechanically attached and sealed to the basin, or preferably it can be a unitary part of the cast or molded basin. And, in any case, the air manifold has to have at least one fitting for coupling an air line leading from the air blower 48.

The air delivery system will now be discussed in more detail with reference to FIG. 8. As mentioned, FIG. 8 depicts a system with zone control which will be discussed shortly, however, both embodiments include the air blower 48, a user control 49, a controller 52 connected to a power source 54, and air lines 56 coupling the outlet of the air blower 48 to the air manifold 50. The bather can use the control to turn on and off the air blower 48 as well as to adjust the air flow by changing the speed of the air blower 48. In the embodiment shown in FIG. 8, the air delivery system also branches of air lines (56A, 56B, 56C and 56D) for each of the channels (50A′, 50B′, 50C′ and 50D′) of the air manifold 50′. Air flow through air line 56A′ and channel 50A′ is controlled by a butterfly valve 60A. Air flow through both air lines 56B and 56C and respective channels 50B′ and 50C′ is controlled by a single butterfly valve 60B. Air flow through air line 56D and channel 50D′ is controlled by butterfly valve 60C. All of the valves are independently controllable by the controller 52 and electronically actuated actuators 62A-62C connected to the controller 52. The user control for this system can have a touch pad or other button for the bather to select the zone to supply air to, which signals the controller 52 to open or close one or more of the valves 60A-60C. A full-body selection can also be provided on the user control for simultaneously opening all three valves 60A-60C. Although not shown, one-way check valves can be included in the air delivery system to prevent back flow. And, in the preferred form shown in FIG. 8, the user control and controller 52 can also be used to operate the chromatherapy system 18 (including light box 70 and lights 72 mounted to the side walls) to illuminate the bath water one or more colors.

Preferred embodiments of the invention have been described in detail. However, the invention may be applied in a variety of other embodiments which are within the scope of the invention. Thus, to ascertain the full scope of the invention, the following claims should be referenced.

### INDUSTRIAL APPLICABILITY

The invention provides an air jet system for bathtubs.

1. An air bath, comprising:
a basin having a bottom and side walls;
a plurality of air jets extending through the side walls and arranged in spaced relation in a plurality of rows extending essentially around the perimeter of the side walls, wherein each row is at different height; and
an air manifold extending around the side walls of the basin in communication with the air jets.

2. The air bath of claim 1, wherein there are three rows of air jets.

3. The air bath of claim 1, wherein the rows of air jets are spaced apart vertically no less than ½ inch.

4. The air bath of claim 3, wherein the rows of air jets are spaced apart vertically ⅝ inch.

5. The air bath of claim 1, wherein the air jets are less than ¼ inch in diameter.

6. The air bath of claim 5, wherein the air jets are 3/32 inch to ⅛ inch in diameter.

7. The air bath of claim 1, wherein there are between 20 and 60 air jets in at least one of the rows of air jets.

8. The air bath of claim 7, wherein each row of air jets includes 40 air jets.

9. The air bath of claim 1, wherein the plurality of rows of air jets are located vertically within a lower half of the side walls of the basin.

10. The air bath of claim 1, wherein the air jets of at least one of the rows of air jets is vertically staggered with respect to at least one other of the rows of air jets.

11. The air bath of claim 1, wherein the air manifold is integral with an outer side of the side walls.

12. The air bath of claim 11, wherein the air manifold is a single air channel having an interior in communication with all of the air jets.

13. The air bath of claim 11, wherein the air manifold has a plurality of air channels arranged in a circuit around the basin, wherein each of the air channels is in communication air jets in a zone of the basin.

14. The air bath of claim 13, wherein air flow through each air channel is independently controllable.

15. The air bath of claim 1, wherein groups of air jets correspond to a plurality of zones in the basin and a plurality of air channels of the air manifold, and wherein air flow through the air channels is independently controllable.

16. The air bath of claim 15, further including an operating control for selecting the zone to deliver air to.

17. The air bath of claim 1, further including an air blower and controller for selectively operating the air blower.

18. The air bath of claim 17, further including conduit for routing air from the air blower to the air jets.
